(19) United States
(12) Patent Application Publication
(10) Pub. No.: US 2005/0074292 A1
(43) Pub. Date: Apr. 7, 2005

(54) Solar powered landfill gas extraction well

(76) Inventors: Ronald L. Brookshire, Alpine, CA (US); Travis J. Brookshire, Alpine, CA (US)

Correspondence Address: John L. Rogitz, Esq.;ROGITZ & ASSOCIATES, Suite 3120, 750 "B" Street, San Diego, CA, 92101, US

(21) Appl. No.: 10/676,593

(22) Filed: Oct. 1, 2003

(51) Int. Cl. B09C 1/00

(52) U.S. Cl. 405/129.95; 405/129.2; 405/128.15; 405/128.2

(57) ABSTRACT

A solar powered landfill gas extraction system includes a fan module that extends into the landfill. A fan in the fan module evacuates methane gas from the landfill. The fan is battery powered, and an array of solar cells recharges the battery.

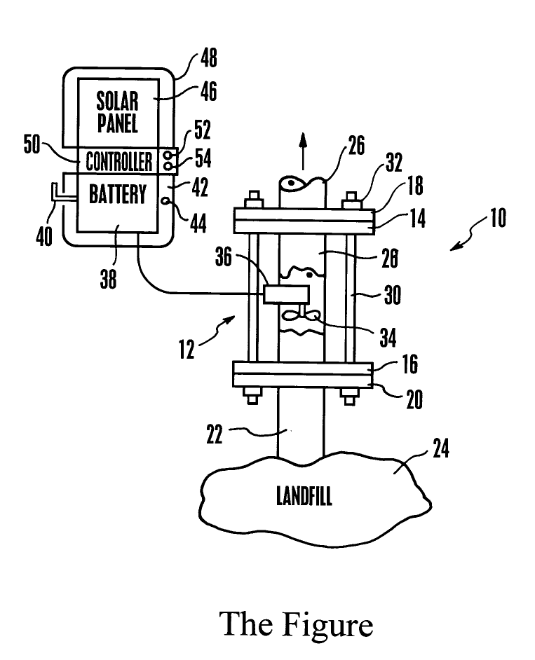

### FIELD OF THE INVENTION

The present invention relates generally to landfill gas extraction systems.

### BACKGROUND OF THE INVENTION

Landfills produce methane gas which must be extracted from the landfills. In some cases, this can be done passively, simply by placing open pipes in the landfill through which the methane can vent. For environmental reasons, however, many localities require that the methane be eliminated as much as possible by actively directing the methane through a flare, which burns the gas. Alternatively, the gas can be treated using filters. Other methods that are less used include simply venting the gas, and using the gas to power an engine, turbine, or boiler.

With respect to flares, two types are generally provided. The first type is referred to as a utility flare, which has a cylindrical flare housing with an open top, above which a flame appears when the flare is burning gas. A methane pipe is within the flare housing, and the methane is pumped up through the pipe and out of an outlet into the flare housing, where an ignition device ignites the gas to produce the flame and oxidize the methane.

A second type of flare is referred to as an enclosed flare. Like a utility flare, an enclosed flare has a methane pipe within the flare housing through which methane rises, to be expelled through an outlet and ignited. Combustion air is provided through louvers in the flare housing wall.

In either case, the flares must be supplied with methane from a fan or fans that evacuate the wells of the landfill. As recognized by the present invention, many landfills may lack the electrical infrastructure to power the various components that are needed to actively eliminate methane from a landfill. Installing the necessary infrastructure can be prohibitively costly.

### SUMMARY OF THE INVENTION

A landfill gas extraction system includes a fan module that is configured for communicating with methane in the landfill. A fan is disposed in the fan module to extract methane out of the landfill when the fan module is engaged with a landfill well. A battery (preferably a 12 volt lead acid battery) powers the fan, and a solar panel is electrically connected to the battery to recharge the battery. The methane may be in gaseous form or liquid (leachate) form.

In a preferred embodiment, the fan is a DC-powered axial fan. The preferred fan module can include a fan pipe holding the fan and first and second flanges engaged with opposite ends of the fan pipe for mating with respective flanges of the landfill well. If desired, support rods can extend through the flanges to securely hold the fan module (e.g., by holding the solar panel) in engagement with the landfill well. A voltage controller can be electrically disposed between the battery and solar panel to maintain a predetermined voltage (e.g., twelve volts or twenty four volts) to the battery.

In another aspect, a method for extracting gas from a landfill well includes installing a fan module in the well. The fan module contains a DC-powered fan. The method also includes energizing the fan using a battery to cause gas to be exhausted from the well, and recharging the battery using an array of solar cells.

In still another aspect, a modular landfill gas extraction system includes fan means in fluid communication with at least one landfill well for exhausting gas therefrom, and battery means for powering the fan means. Solar power means recharge the battery means.

The details of the present invention, both as to its structure and operation, can best be understood in reference to the accompanying drawings, in which like reference numerals refer to like parts, and in which:

### BRIEF DESCRIPTION OF THE DRAWINGS

The FIGURE is an elevational view of the solar-powered landfill gas extraction system, showing the electrical components schematically and showing portions of the fan module pipe cut away to reveal the fan.

### DETAILED DESCRIPTION OF THE PREFERRED EMBODIMENT

Referring to the FIGURE, a solar-powered landfill gas extraction system is shown, generally designated 10. As shown, the system 10 includes a preferably stainless steel fan module 12 that has first and second hollow connecting flanges 14, 16 that mate with respective hollow landfill extraction well flanges 18, 20 to engage the fan module 12 with a landfill well. A landfill well pipe 22 extends away from the flange 20 and is in fluid communication with and preferably physically buried in a landfill 24, so that methane gas generated in the landfill 24 can pass up into the well pipe 22. Likewise, an exhaust pipe 26 extends away from the flange 18. According to the present invention, a fan module pipe 28 is provided as part of the fan module 12, and more specifically the fan module pipe 28 extends between the connecting flanges 14, 16. Accordingly, a methane gas passageway is established from the landfill, through the well pipe 22 and fan module 12, and out of the exhaust pipe 26.

If desired, to hold the below-described panel and also if desired to strengthen the coupling of the fan module 12 with the landfill well pipes 22, 26, reinforcing support rods 30 can extend through the flanges 14, 16, 18, and 20. The support rods 30 are secured with nuts 32 that are threadably engaged with the support rods 30 and that are tightened down against the flanges 18, 20.

As shown in the FIGURE, an axial fan 34 is disposed within the fan module pipe 28. In the preferred embodiment, the fan 34 is a DC-powered axial fan that has a flow rate of forty standard cubic feet per minute (40 SCFM) and that draws up to two inches (2″) of vacuum on the landfill 24 (suction) side of the fan 34. Higher or lower flow rates and vacuums may be used. In any case, a DC motor 36 turns the fan 34.

To energize the motor 36, a battery 38, preferably a twelve volt DC (12 vdc) or twenty four volt dc (24 vdc) rechargeable lead acid battery with one-way overcharge relief valve 40, is electrically connected to the motor 36. The battery can be mounted in a battery housing 42, and a fan on/off switch 44 can be provided on the housing 42 to close and open, respectively, the circuit between the battery 38 and fan motor 36.

To recharge the battery 38 such that no external AC power is required, a solar panel 46 is provided in a panel housing 48. The solar panel 46 includes an array of solar cells for converting sunlight to electricity. In a preferred embodiment, the solar panel housing 48 is made of corrosion resistant, anodized aluminum. While the FIGURE shows the solar panel housing 48 closely juxtaposed with the battery housing 42, the two housings 42, 48 can be spaced apart and the solar panel 46 connected to the battery 38 by an electrical line. Instead of mounting on the support rods 30, in some embodiments the solar panel housing and battery housing can be mounted on a common mount that is disposed at or near the landfill well with which the fan module 12 is engaged.

A voltage controller 50 preferably is provided in the electrical circuit between the solar panel 46 and battery 38 to regulate the output of the solar panel 46 and to maintain twelve volts dc to the battery 38 in accordance with voltage regulation principles known in the art. The preferred controller 50 has two light emitting diodes (LEDs) 52, 54 that respectively indicate charging and shunting status, e.g., when the LED 52 is on, it indicates that charging is occurring. The voltage controller 50 can also have fused protection. With the above combination of structure, the system 10 can operate up to forty eight hours with poor sunlight conditions.

While the particular SOLAR POWERED LANDFILL GAS EXTRACTION WELL as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconciliable with the present specification and file history.

1. A landfill gas extraction system, comprising:
at least one fan module configured for communicating with methane in the landfill;
at least one fan disposed in the fan module to extract methane out of the landfill when the fan module is engaged with a landfill well of the landfill and the fan is activated;
at least one battery for powering the fan;
at least one solar panel electrically connected to the battery to recharge the battery, the fan module comprising:
a fan pipe holding the fan and first and second flanges engaged with opposite ends of the fan pipe for mating with respective flanges of a landfill well, the fan being disposed between the flanges.

2. The system of claim 1, wherein the fan is a DC-powered fan.

3. The system of claim 2, wherein the fan is an axial fan.

4. (canceled).

5. The system of claim 1, further comprising at least one support rod extending through at least two flanges.

6. The system of claim 1, wherein the battery is a rechargeable lead acid twelve volt battery.

7. The system of claim 1, wherein the solar panel includes an array of solar cells for converting sunlight to electricity.

8. The system of claim 1, further comprising a voltage controller electrically disposed between the battery and solar panel to maintain a predetermined voltage to the battery.

9. A method for extracting gas from a landfill well, comprising:
installing a fan module in the well, the fan module containing at least one DC-powered fan;
energizing the fan using at least one battery to cause fluid to be exhausted from the well; and
recharging the battery using at least one solar cell.

10. The method of claim 9, further comprising securing engagement of the fan module with the landfill well using at least one support rod.

11. The method of claim 9, wherein the battery is a twelve volt lead acid battery, and is the sole source of power for the fan.

12. The method of claim 9, wherein the fan is an axial fan.

13. The method of claim 9, comprising exhausting gas from the well at a rate of about forty standard cubic feet per minute or greater.

14. The method of claim 9, comprising maintaining twelve volts DC to the battery.

15. A modular landfill gas extraction system, comprising:
fan means in fluid communication with at least one landfill well for exhausting gas therefrom;
battery means for powering the fan means; and
solar power means for recharging the battery means.

16. The system of claim 15, wherein the fan means includes at least one DC-powered fan disposed in a fan module, the battery means includes a lead acid battery, and the solar power means includes at least one solar panel.

17. The system of claim 16, wherein the fan is an axial fan.

18. The system of claim 16, wherein the fan module includes a fan pipe holding the fan and first and second flanges engaged with opposite ends of the fan pipe for mating with respective flanges of the landfill well.

19. The system of claim 18, further comprising at least one support rod extending through at least two flanges to securely hold the fan module in engagement with the landfill well.

20. The system of claim 16, further comprising voltage control means electrically disposed between the battery and solar panel for maintaining twelve volts to the battery.
